(19) United States
(12) Patent Application Publication
(10) Pub. No.: US 2018/0062686 A1
(43) Pub. Date: Mar. 1, 2018

(54) Tethered Stylus within a concealed compartment of a protective case

(71) Applicant: Lee Joan Lucente, Jacksonville, FL (US)

(72) Inventor: Lee Joan Lucente, Jacksonville, FL (US)

(21) Appl. No.: 15/250,893

(22) Filed: Aug. 29, 2016

(51) Int. Cl. H04B 1/3888; A45C 11/00

(52) U.S. Cl. CPC H04B 1/3888; A45C 2011/002; A45C 11/00

(57) ABSTRACT

The present invention comprises a protective case for a portable electronic device adapted with a storage compartment which houses a tethered stylus. The tethered stylus can be retractable. The stylus is attached to the protective case by way of a permanent tether and the storage compartment is integrally attached at one end of the protective case.

This case claims the benefit of provisional application 62/300,943.

### BACKGROUND OF THE INVENTION

This invention relates to the field of devices made for operation of touch responsive user interfaces.

Portable electronic devices (PEDs) such as PDAs, computers, MP3 players, video players, smart phones, IPhones, IPads, GPS receivers, telematics devices, cell phones, satellite phones, pagers, monitors, etc., are being very widely used today. Normally, a user would operate the touch-screen of the PEDs with a finger or a provided stylus. However, stylus can be easily lost if not attached to the PED. What is needed is a means of attaching a stylus that is aesthetically pleasing while not in use as well as allowing the user to comfortably access the PED when the stylus is in use.

### SUMMARY OF THE INVENTION

One objective of this invention is to minimize the time and labor of finding a lost stylus.

Other objectives of this invention are as follows:
a. to have a permanently tethered stylus that is never lost or misplaced;
b. to have a tethered stylus with a cord of the appropriate length which is comfortable to use;
c. to make the tethered cord tangle free by having a compartment to store it in; and

to provide storage for the stylus and other small office article accessories such as an extra pen, or small office articles such as paper clips.

The present invention comprises a storage compartment integrally attached to a protective case for a portable electronic device. A stylus is tethered within the compartment. The stylus allows the user to interact with the PED by inputting information into the electronic device. While not in use, the tethered stylus is concealed within the storage compartment. The storage compartment can be manufactured to fit a variety of sizes of portable electronics devices.

The storage compartment extends from a peripheral edge of one side of the PED protective case and can be made of flexible material such as silicon. The storage compartment has an opening on the side that allows for the stylus to be placed therein. The cord is tethered inside of the compartment to an appropriate length and can be retractable therein.

### BRIEF DESCRIPTION OF DRAWINGS

These and other details of the present invention will be described in connection with the accompanying drawings, which are not furnished only by way of illustration and not in limitation of the invention.

FIG. 1 is a diagram of a stylus lanyard having a first attachment means.

FIG. 1a depicts a cell phone which includes all types of PEDs that could fit into a protective case.

FIG. 2 is a diagram view of the case with the tether attached to the stylus from an outstretched view from the stylus compartment.

FIG. 3 is a top view of the upper section of the present invention.

FIG. 3a is a side cutaway view of the of the storage compartment.

FIG. 4 is an open view of an alternative protective case for a tablet or IPad type device showing an exploded view of the tether and stylus from the compartment.

FIG. 4a is a side view of a tablet or IPad.

FIG. 5 is a cutaway view of the tether, stylus, and retracting apparatus.

FIG. 5a is a cutaway view of the retracting apparatus.

FIG. 6 is a cutaway view of the spring for the retracting apparatus.

### DETAILED DESCRIPTION OF THE INVENTION

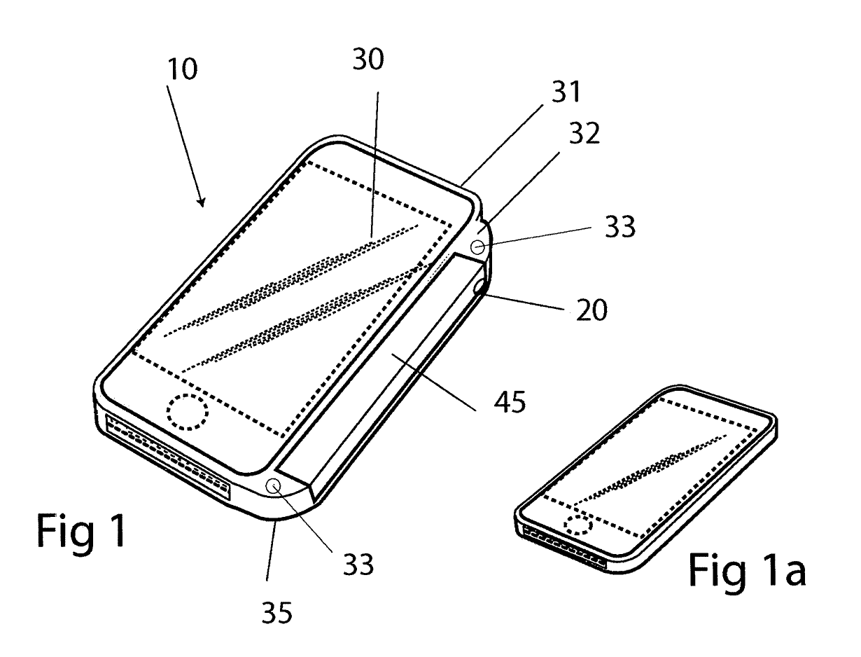

Referring to FIG. 1, a protective case for a PED is shown in exemplary form. The invention herein discloses a stylus (25) which is positioned in a provided storage compartment (45) integrally attached to the peripheral edge of one side of the protective case (10).

FIG. 1 illustrated one embodiment of the protective case (10). As depicted, the protective case (10) includes a lower housing (35) with an attached storage compartment (45); a mounting face (30) sized to receive the back face (32) of a PED (31); and a device-securing means for securing the PED within the protective case (10). The size and shape of the protective case (10) may vary for different sizes, makes, models and types of portable electronic devices. The case (10) can be made from a molded polymer material, flexible silicon or another suitable flexible material. The case (10) will be configured so as not to detract from other features of the device (31) such as volume controls, recharging ports, cameras and other features.

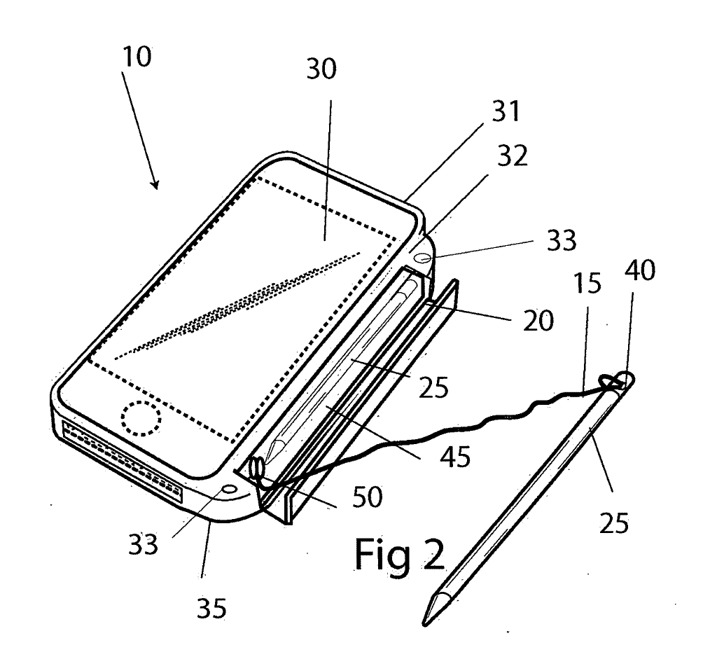

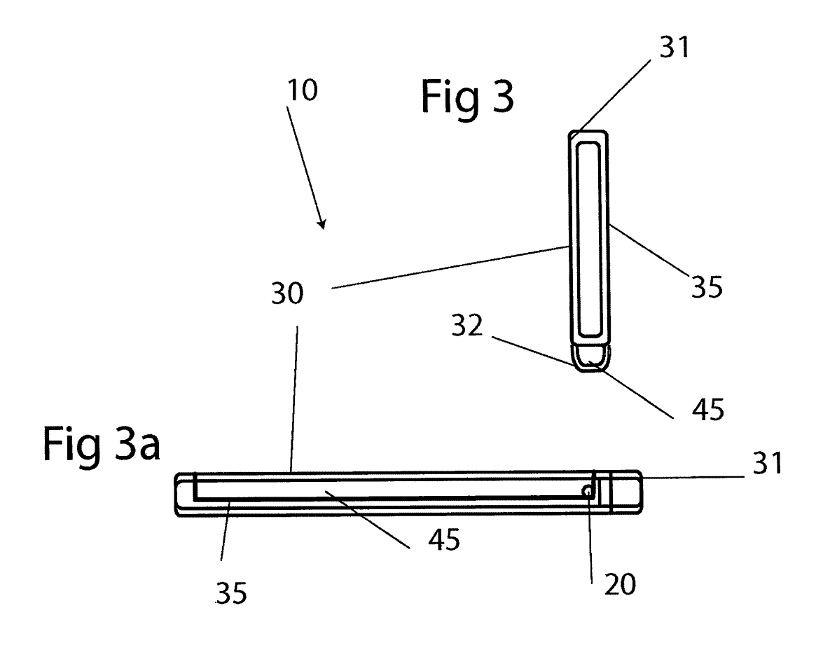

As shown in FIGS. 1-2, lower housing (35) is configured to be secured to the back face of the device (31) disposed below the display screen which is the upper face of the PED (31). Lower housing (35) is preferably sized to approximate or match the dimensions of the back face (32) of device (31) to form an unobtrusive extension of the device (31) in order to maintain device's (31) convenience, aesthetics and portability. The housing (35) receives the device (31) without obscuring the screen for use and where the back, bottom, sides and upper portion is against or adjacent to the housing (35) when the PED (31) is securely placed within lower housing (35).

The device-securing means may be one or more structures integrated with the lower housing (35) such as (but not limited to) the snap tabs formed on mounting face, lip or frame. Device securing means (33) secures the upper face of the PED (31) within the open face of housing (35).

Compartment (45) is a integrally attached to one side of the case (10) and conceals stylus (25) while not in use. As depicted compartment (45) extends vertically downward the length of case (10). A hingedly connected lid traverses between an opened and closed position allowing stylus (25) to be concealed therein.

A small pen-shaped stylus (25) is utilized in much the same way as a pen. As depicted stylus (25) comprises a small cylindrical shaft that has a sharpened point on one end. Stylus (25) is a writing utensil that can be used as a computer accessory which can be used to navigate and provide precision when using any touch-screen device. The stylus (25) allows the user to make contact with the touch-screen commands or small buttons. Using a fingertip in place of the stylus (25) is sometimes difficult, as the tip of a finger is broad compared to the small touch-screen command buttons.

The stylus (25) is attached by way of a tether (15) within compartment (45). A tether (15) is a cord, fixture, or flexible attachment that anchors something that is movable to a reference point which may be fixed or moving. The tether (15) has a sufficient length and flexibility so that the device can be readily operated with the stylus (25).

The tether (15) can be made of plastic cord or another suitable type of material. A anchor support (50) can be located on a corner within compartment (45). The stylus (25) has an eyelet (40) on one end, and the tether (15) is looped through the eyelet (40). Stylus (25) can be made of plastic, aluminum or another suitable material. Tether (15) have one end securely attached within compartment (45) and the opposite end attached to the end of the shaft of stylus (25).

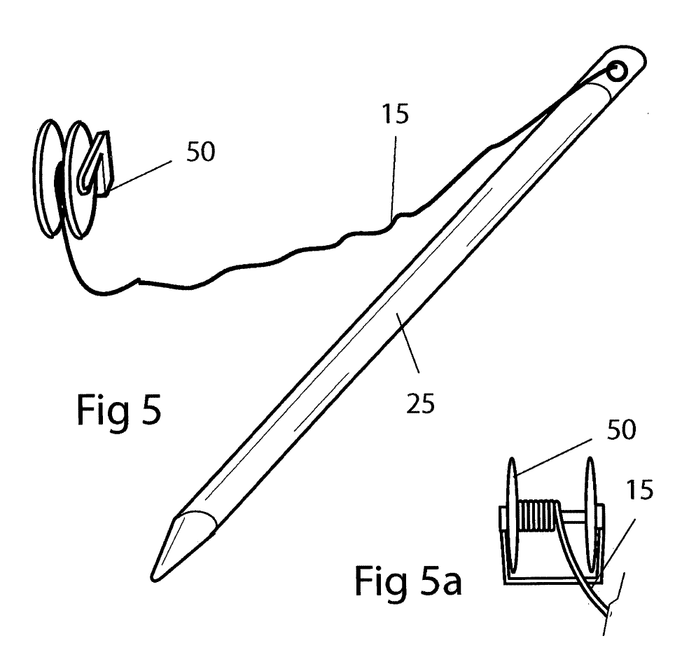

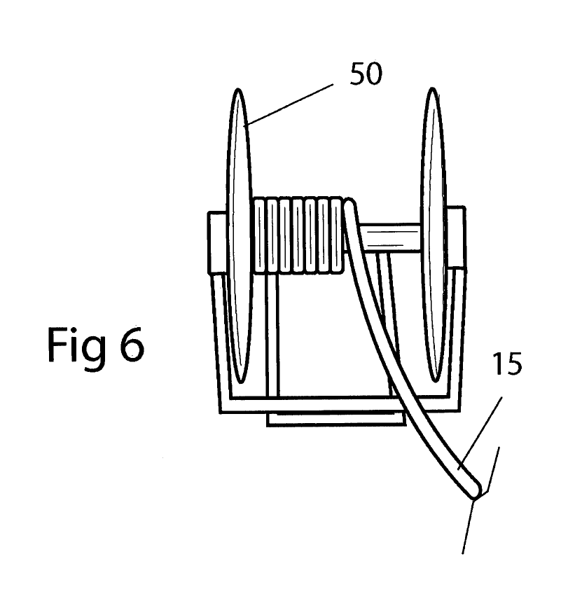

In an alternative embodiment, anchor support (50) can be retractable as depicted in FIGS. 5, 5a and 6. Retracting apparatus (50) is operationally connected to the stylus (25) and securely mounted within a portion of compartment (45). In the depicted embodiment, retracting apparatus (50) has a spool upon which tether (15) is wrapped around. In other embodiments retracting apparatus (50) can be coil-type or spring biased which provide the function of allowing the stylus (25) to be pulled from the compartment (45) for use on the PED, and then upon release to be automatically retracted back into compartment (45). The retracting means (50) can be increased or decreased in strength to meet the requirements for extracting the stylus (25) therefrom.

As depicted, the stylus storage compartment (45) has a closed bottom side with a hingedly connected lid that opens and closes to conceal the tethered stylus (25) therein. In other embodiments the storage compartment (45) bottom side can have small recess areas to contain storage of small office articles such as paper clips, pen or other small accessory items. Compartment (45) containing the stylus (25) and retracting apparatus (50) is designed to allow for all technical features of the device (31) to be accessed as are other protective cases in the industry.

Referring generally now to FIGS. 2 and 5, the stylus (25) is secured to the retracting means (50). In the illustrated embodiment, stylus (25) has an eyelet (40) on the end opposite the pointed end. The tether (15) is threaded through the eyelet (40) to secure the stylus (25) thereto. Additionally the eyelet (40) is structured to prevent tethered cord from being tangled during use.

Retracting means (50) may take different forms, and the retraction force may be provided by spring-tension as shown in FIG. 5. The spring-tensioned retracting means (50) is designed to automatically retract stylus (25) back into concealed compartment. Illustrated retracting means (50) includes a spring reel mechanism comprising a coiled torsion spring wound around and secured to a post to an inner end and containing a rotatable wheel. The retracting apparatus (50) is attached to and constructed within the stylus storage compartment (45). In the illustrated embodiment, the retracting apparatus (50) is attached at the upper end of compartment (45).

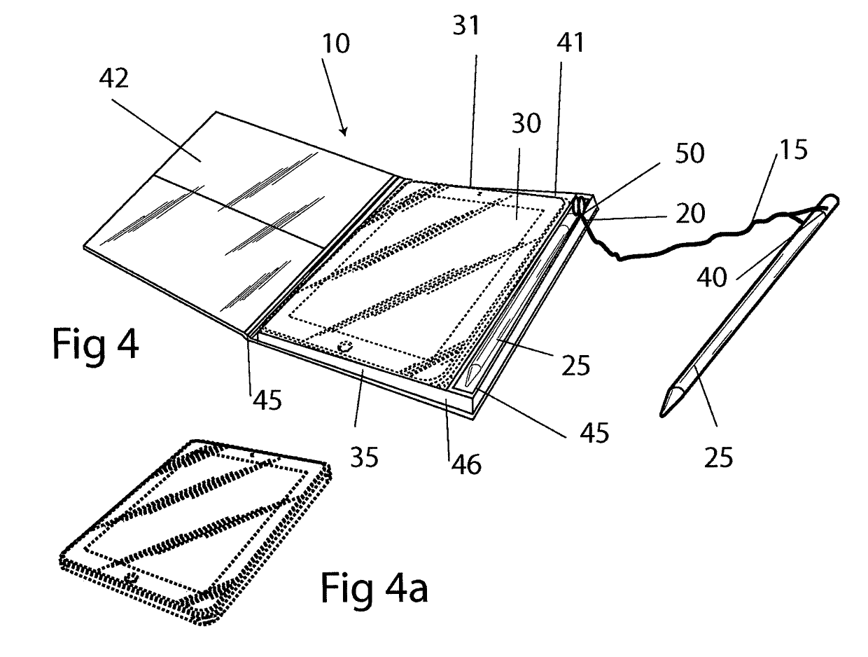

Depicted in FIGS. 4 and 4a is an alternative embodiment of protective case (10). In this illustrated embodiment, the front cover (42) is hingedly connected to a back cover (46) which receives the backside of a notebook computer (41), IPad or another suitable size PED. The back cover (46) forms a storage compartment that receives the notebook computer (31) therein. Device securing means secures the notebook computer (31) within back cover storage compartment (46). Storage compartment (45) extends vertically the length of the back cover (46) and receives stylus (25) therein. The storage compartment can be configured to extend beyond any protective case that encloses a PED.

1. A protective enclosure for storage of a stylus that is attached to a protective case of personal electronic device (PED), the protective enclosure further comprising:
an elongated body defined by an upper shell and a lower shell that are connected for enclosing the stylus;
the elongated body being attached to a peripheral edge of the protective case protruding longitudinally outward along the peripheral edge;
a storage area formed between the upper and the lower shell for enclosing the stylus there in;
the upper shell having an upper inner wall disposed atop the lower shell having a lower inner wall surrounding the storage area therebetween;
the lower inner wall forming a laterally extending base to support the stylus thereon;
the stylus being a separate unit from the elongated body, PED, and the protective case;
a tether having one end operationally connected to an anchor support which is operationally mounted to an inner wall within the storage area of the elongated body between the upper and lower shell and having an opposite end operationally attached to the stylus;
an opening within the elongated body wherein the stylus can be placed within and removed from the storage area between the upper and lower shell.

2. The protective enclosure of claim 1 wherein the upper shell forms a lid that is removably connected to the lower shell along the peripheral edge with the capability of transitioning between an opened and closed position for allowing the stylus to be placed within and removed from the storage area.

3. The protective enclosure of claim 2 wherein the lid is hingedly attached to a side edge of the lower shell providing the capability of transitioning between an opened and closed position for allowing the stylus to be placed within and removed from the storage area.

4. The protective enclosure of claim 1 wherein a small retractable unit disposed within the elongated body is operationally coupled to the anchor support and to the tether providing the ability to retract and release the tether to a desired length while the stylus is in use.

5. The protective enclosure of claim 1 wherein the elongated body is configured to connect and to protrude from any edge of the protective case.

6. The protective enclosure of claim 1 wherein the lower inner wall of the lower shell further comprises at least one small fastener operationally coupled thereto for attaching to small accessory items therein.

7. The protective enclosure of claim 1 wherein the upper inner wall of the upper shell the further comprises at least one small fastener operationally coupled thereto for attaching to small accessory items therein.

8. The protective enclosure of claim 1 wherein the anchor support further comprises a spring biased retracting unit operationally connected therein within the elongated body.

9. The protective enclosure of claim 1 wherein the tether is a flexible cord of a predetermined length.
